(19) United States
(12) Patent Application Publication
(10) Pub. No.: US 2024/0430681 A1
(43) Pub. Date: Dec. 26, 2024

(54) COMMUNICATION DEVICES AND METHODS THEREIN FOR FACILITATING IKE COMMUNICATIONS

(71) Applicant: Telefonaktiebolaget LM Ericsson (PUBL), Stockholm (SE)

(72) Inventors: Daiying Liu, Beijing (CN); Gang Yang, BEIJING (CN); Yiqun Li, Beijing (CN)

(21) Appl. No.: 18/704,116

(22) PCT Filed: Oct. 29, 2021
(86) PCT No.: PCT/CN2021/127311

§ 371 Date: Apr. 24, 2024

(51) Int. Cl. H04W 12/10; H04W 12/043; H04W 12/06

(52) U.S. Cl. CPC H04W 12/10; H04W 12/043; H04W 12/06

(57) ABSTRACT

The present disclosure provides a method (200) performed by a first communication device. The method (200) includes: receiving (210) a request from a second communication device, the request containing a first pair of Traffic Selectors, TSs; and transmitting (220) a response to the second communication device. When the first pair of TSs and a second pair of TSs existing at the first communication device at least partially overlap, the response contains a notification of a conflict between the first pair of TSs and the second pair of TSs.

### TECHNICAL FIELD

The present disclosure relates to communication technology, and more particularly, to communication devices and methods therein for facilitating Internet Key Exchange (IKE) communications.

### BACKGROUND

The Internet Engineering Task Force (IETF) Request for Comments (RFC) 7296, Internet Key Exchange Protocol Version 2 (IKEv2), which is incorporated herein by reference in its entirety, describes version 2 of the Internet Key Exchange (IKE) protocol. IKE is a component of Internet Protocol (IP) Security (IPsec) used for performing mutual authentication and establishing and maintaining Security Associations (SAs).

IPsec provides confidentiality, data integrity, access control, and data source authentication to IP datagrams. These services are provided by maintaining shared state between the source and the sink of an IP datagram. This state defines, among other things, the specific services provided to the datagram, which cryptographic algorithms will be used to provide the services, and the keys used as input to the cryptographic algorithms.

IKE performs mutual authentication between two parties and establishes an IKE Security Association (SA) that includes shared secret information that can be used to efficiently establish SAs (referred to as child SAs) for Encapsulating Security Payload (ESP) or Authentication Header (AH) and a set of cryptographic algorithms to be used by the SAs to protect the traffic that they carry.

Traffic Selector (TS) payloads (IKEv2 Payload Type) allow endpoints to communicate with their peers to specify the selection criteria for packets that will be forwarded over the established SA.

### SUMMARY

TS negotiation is independent for different IKE sessions, and it is possible to two or more TSs at least partially overlapping each other. In this case, a packet may hit more than one TS and thus does not know which IKE tunnel it should enter, or enters an incorrect IKE tunnel. This could affect the performance of the network service.

To solve the above problem, priorities can be pre-assigned to TSs, e.g., by an administrator manually when the TSs are configured. For example, it is a typical scenario that some packets with a special purpose or special importance may enter a special IKE tunnel, while others may enter a default IKE tunnel. In this scenario, the TS of the special IKE tunnel may be completely included by the TS of the default IKE tunnel, and the TS of the special IKE tunnel can be manually assigned with a higher priority than the default IKE tunnel. However, sometimes such overlap between TSs is not expected, but due to misconfiguration or erroneous IP address allocation. The administrator is often not aware of these errors. In addition, there are typically a large number of IKE tunnels on a security gateway, and thus manual assignment of the priorities of TSs will be a heavy workload and will be error-prone. Moreover, if there are traffic problems caused by such overlap as described above, in most cases it is not obvious immediately after deployment. It may be found that some packets cannot enter the correct tunnel after a long time only when packets with specific IP addresses appear, thus having an impact on the current network service, especially for a security gateway where it is difficult to debug such problem due to the large number of IKE tunnels.

It is an object of the present disclosure to provide communication devices and methods therein, capable of solving, or at least mitigating the impact of, the above problem.

According to a first aspect of the present disclosure, a method performed by a first communication device is provided. The method includes: receiving a request from a second communication device, the request containing a first pair of TSs; and transmitting a response to the second communication device. When the first pair of TSs and a second pair of TSs existing at the first communication device at least partially overlap, the response contains a notification of a conflict between the first pair of TSs and the second pair of TSs.

In an embodiment, when the first pair of TSs has a first pre-assigned priority and the second pair of TSs has a second pre-assigned priority, the notification may be a status notification and may indicate the first pre-assigned priority and the second pre-assigned priority or indicates which of the first pair of TSs and the second pair of TSs has a higher or lower pre-assigned priority.

In an embodiment, the notification may be an error notification when neither of the first pair of TSs and the second pair of TSs has a pre-assigned priority, and when neither of the first pair of TSs and the second pair of TSs is completely included by the other.

In an embodiment, the method may further include, when neither of the first pair of TSs and the second pair of TSs has a pre-assigned priority, and when one of the first pair of TSs and the second pair of TSs is completely included by the other: assigning a first priority to the one pair of TSs and a second priority to the other pair of TSs. The first priority is higher than the second priority. The notification may be a status notification and may indicate the first priority and the second priority or indicates which of the first pair of TSs and the second pair of TSs has a higher or lower priority assigned at the first communication device.

In an embodiment, the first priority and the second priority may be assigned in response to a priority assignment function being enabled.

In an embodiment, the notification may be an error notification when neither of the first pair of TSs and the second pair of TSs has a pre-assigned priority, and when one of the first pair of TSs and the second pair of TSs is completely included by the other and a priority assignment function is disabled.

In an embodiment, the request may be an Internet IKE Authentication (IKE_AUTH) request and the response may be an IKE_AUTH response, or the request may be a Create Child Security Association (CREATE_CHILD_SA) request and the response may be a CREATE_CHILD_SA response.

In an embodiment, the notification may be included in the response in response to a conflict notification function being enabled.

According to a second aspect of the present disclosure, a method performed by a second communication device is provided. The method includes: transmitting a request to a first communication device, the request containing a first pair of TSs; and receiving a response from the first communication device. The response contains a notification of a conflict between the first pair of TSs and a second pair of TSs existing at the first communication device.

In an embodiment, the notification may be an error notification.

In an embodiment, the notification may be a status notification and may indicate a priority of the first pair of TSs and a priority of the second pair of TSs or indicate which of the first pair of TSs and the second pair of TSs has a higher or lower priority.

In an embodiment, each priority may be a pre-assigned priority or a priority assigned at the first communication device.

In an embodiment, the request may be an IKE_AUTH request and the response may be an IKE_AUTH response, or the request may be a CREATE_CHILD_SA request and the response may be a CREATE_CHILD_SA response.

According to a third aspect of the present disclosure, a first communication device is provided. The first communication device includes a communication interface, a processor and a memory. The memory contains instructions executable by the processor whereby the first communication device is operative to perform the method according to the above first aspect.

According to a fourth aspect of the present disclosure, a computer program is provided. The computer program contains instructions which, when executed by a processor of a first communication device, configure the first communication device to perform the method according to the above first aspect.

According to a fifth aspect of the present disclosure, a computer-readable storage medium is provided. The computer-readable storage medium has computer-readable instructions stored thereon. The computer-readable instructions, when executed by a processor of a first communication device, configure the first communication device to perform the method according to the above first aspect.

According to a sixth aspect of the present disclosure, a second communication device is provided. The second communication device includes a communication interface, a processor and a memory. The memory contains instructions executable by the processor whereby the second communication device is operative to perform the method according to the above second aspect.

According to a seventh aspect of the present disclosure, a computer program is provided. The computer program contains instructions which, when executed by a processor of a second communication device, configure the second communication device to perform the method according to the above second aspect.

According to an eighth aspect of the present disclosure, a computer-readable storage medium is provided. The computer-readable storage medium has computer-readable instructions stored thereon. The computer-readable instructions, when executed by a processor of a second communication device, configure the second communication device to perform the method according to the above second aspect.

With the embodiments of the present disclosure, when a first communication device receives from a second communication device a request containing a first pair of TSs and when the first pair of TSs and a second pair of TSs existing at the first communication device at least partially overlap, the first communication device can transmit to the second communication device a response containing a notification of a conflict between the first pair of TSs and the second pair of TSs. In this way, the TS conflict can be explicitly exposed, so as to e.g., allow an administrator to change TS configurations and/or reallocate IP addresses to avoid such problem.

### BRIEF DESCRIPTION OF THE DRAWINGS

The above and other objects, features and advantages will be more apparent from the following description of embodiments with reference to the figures, in which:

FIG. 1 is a sequence diagram showing message exchanges for IKE communication;

FIG. 2 is a flowchart illustrating a method according to an embodiment of the present disclosure;

FIG. 3 is a schematic diagram showing a message format for a status notification;

FIG. 4 is a schematic diagram showing a message format for an error notification;

FIG. 5 is a flowchart illustrating a method according to another embodiment of the present disclosure;

FIG. 6 is a block diagram of a first communication device according to an embodiment of the present disclosure; and

FIG. 7 is a block diagram of a second communication device according to an embodiment of the present disclosure.

### DETAILED DESCRIPTION

As used herein, the term “communication device” refers to any device or node in a wired or wireless communication network. For example, a communication device may be a network device or node, such as an access network node or a core network node. Alternatively, a communication device may be a terminal device, such as a User Equipment (UE), that can access a communication network.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

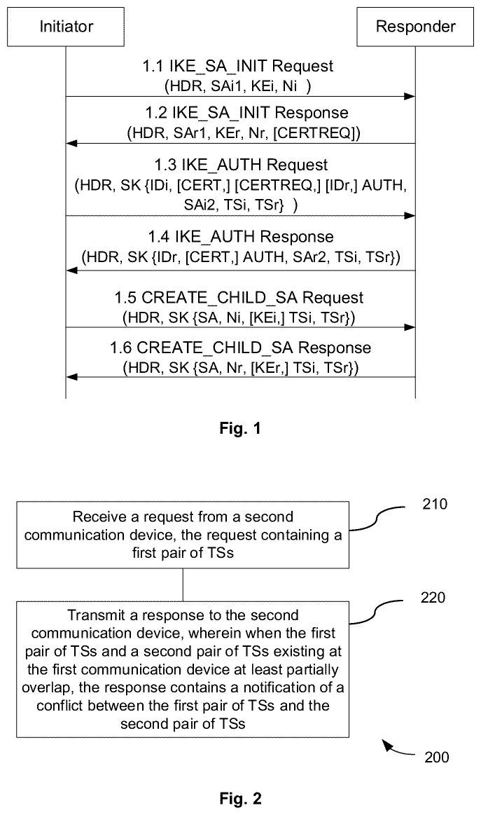

FIG. 1 is a sequence diagram showing message exchanges for IKE communication. FIG. 1 shows an IKE_SA_INIT Exchange (1.1 and 1.2), an IKE_AUTH Exchange (1.3 and 1.4), and a CREATE_CHILD_SA Exchange for creating new Child SAs (1.5 and 1.6). The payloads contained in the message are indicated by names as listed below.

| Notation | Payload |
|---|---|
| AUTH | Authentication |
| CERT | Certificate |
| CERTREQ | Certificate Request |
| CP | Configuration |
| D | Delete |
| EAP | Extensible Authentication |
| HDR | IKE header (not a payload) |
| IDi | Identification—Initiator |
| IDr | Identification—Responder |
| KE | Key Exchange |
| Ni, Nr | Nonce |
| N | Notify |
| SA | Security Association |
| SK | Encrypted and Authenticated |
| TSi | Traffic Selector—Initiator |
| TSr | Traffic Selector—Responder |
| V | Vendor ID |

At 1.1, an initiator sends an IKE_SA_INIT request to a responder, containing HDR, SAi1, KEi, Ni. Here, HDR contains the Security Parameter Indexes (SPIs), version numbers, Exchange Type, Message ID, and flags of various sorts. The SAi1 payload states the cryptographic algorithms the initiator supports for the IKE SA. The KE payload sends the initiator's Diffie-Hellman value. Ni is the initiator's nonce.

At 1.2, the responder responds with an IKE_SA_INIT response, containing HDR, SAr1, KEr, Nr, [CERTREQ] (payloads that may optionally appear will be shown in brackets, and [CERTREQ] indicates that a Certificate Request payload can optionally be included). Here, the responder chooses a cryptographic suite from the initiator's offered choices and expresses that choice in the SAr1 payload, completes the Diffie-Hellman exchange with the KEr payload, and sends its nonce in the Nr payload.

At 1.3, the initiator sends an IKE_AUTH request to the responder, containing HDR, SK {IDi, [CERT,] [CERTREQ,] [IDr,] AUTH, SAi2, TSi, TSr}. Here, the initiator asserts its identity with the IDi payload, proves knowledge of the secret corresponding to IDi and integrity protects the contents of the first message using the AUTH payload. It might also send its certificate(s) in CERT payload(s) and a list of its trust anchors in CERTREQ payload(s). If any CERT payloads are included, the first certificate provided must contain the public key used to verify the AUTH field. The optional payload IDr enables the initiator to specify to which of the responder's identities it wants to talk. This is useful when the machine on which the responder is running is hosting multiple identities at the same IP address. If the IDr proposed by the initiator is not acceptable to the responder, the responder might use some other IDr to finish the exchange. If the initiator then does not accept the fact that responder used an IDr different than the one that was requested, the initiator can close the SA after noticing the fact. Two TS payloads, TSi and TSr, are also included. Each TS payload contains one or more TSs. Each TS consists of an address range (IPv4 or IPv6), a port range, and an IP protocol ID. TSi specifies the source address of traffic forwarded from (or the destination address of traffic forwarded to) the initiator of the Child SA pair. TSr specifies the destination address of the traffic forwarded to (or the source address of the traffic forwarded from) the responder of the Child SA pair. For example, if the original initiator requests the creation of a Child SA pair, and wishes to tunnel all traffic from subnet 198.51.100.* on the initiator's side to subnet 192.0.2.* on the responder's side, the initiator would include a single TS in each TS payload. TSi would specify the address range (198.51.100.0-198.51.100.255) and TSr would specify the address range (192.0.2.0-192.0.2.255). Assuming that proposal was acceptable to the responder, it would send identical TS payloads back. The initiator begins negotiation of a Child SA using the SAi2 payload. The final fields (starting with SAi2) are described in the description of the CREATE_CHILD_SA exchange.

At 1.4, the responder responds with an IKE_AUTH response, containing HDR, SK {IDr, [CERT,] AUTH, SAr2, TSi, TSr}. Here, the responder asserts its identity with the IDr payload, optionally sends one or more certificates (again with the certificate containing the public key used to verify AUTH listed first), authenticates its identity and protects the integrity of the second message with the AUTH payload, and completes negotiation of a Child SA with the additional fields described below in the CREATE_CHILD_SA exchange.

At 1.5, the initiator sends a CREATE_CHILD_SA request to the responder for creating a Child SA. The request contains HDR, SK {SA, Ni, [KEi,] TSi, TSr}. Here, the initiator sends SA offer(s) in the SA payload, a nonce in the Ni payload, optionally a Diffie-Hellman value in the KEi payload, and the proposed Traffic Selectors for the proposed Child SA in the TSi and TSr payloads.

At 1.6, the responder responds with a CREATE_CHILD_SA response, containing HDR, SK {SA, Nr, [KEr,] TSi, TSr}. Here, the responder replies (using the same Message ID to respond) with the accepted offer in an SA payload, a nonce in the Nr payload, and a Diffie-Hellman value in the KEr payload if KEi was included in the request and the selected cryptographic suite includes that group. The Traffic Selectors for traffic to be sent on that SA are specified in the TS payloads in the response, which may be a subset of what the initiator of the Child SA proposed.

For further details of the IKE_SA_INIT Exchange, IKE_AUTH Exchange, and CREATE_CHILD_SA Exchange, reference can be made to RFC 7296.

FIG. 2 is a flowchart illustrating a method 200 according to an embodiment of the present disclosure. The method 200 can be performed by a first communication device, e.g., the responder shown in FIG. 1.

At block 210, a request is received from a second communication device (e.g., the initiator shown in FIG. 1). The request contains a first pair of TSs (e.g., TSi and TSr as described above).

At block 220, a response is transmitted to the second communication device. When the first pair of TSs and a second pair of TSs existing at the first communication device at least partially overlap, the response contains a notification of a conflict between the first pair of TSs and the second pair of TSs.

Here, a pair of TSs, (TS11, TS12), specifying a source address range, Saddr1, and a destination address range, Daddr1, at least partially overlaps another pair of TSs, (TS21, TS22), specifying a source address range, Saddr2, and a destination address range, Daddr2, when Saddr1 and Saddr2 at least partially overlap and Daddr1 and Daddr2 at least partially overlap. In this context, (TS11, TS12) is completely included by (TS21, TS22) when Saddr1 is completely included by, or is a subset of, Saddr2 and Daddr1 is completely included by, or is a subset of, Daddr2. For example, (TS11, TS12) specifying Saddr1=4.4.4.4/24 and Daddr1=7.7.7.7/24 is completely included by (TS21, TS22) specifying Saddr2=4.4.4.4/16 and Daddr2=7.7.7.7/16.

Here, for example, the request may be an IKE_AUTH request (e.g., as shown at 1.3 of FIG. 1) and the response may be an IKE_AUTH response (e.g., as shown at 1.4 of FIG. 1). Alternatively, the request may be a CREATE_CHILD_SA request (e.g., as shown at 1.5 of FIG. 1) and the response may be a CREATE_CHILD_SA response (e.g., as shown at 1.6 of FIG. 1).

Here, the notification may be included in the response in the block 220 in response to a conflict notification function being enabled. That is, the conflict notification function can be enabled or disabled, e.g., by an administrator, to provide flexibility in configuration.

In an example, when the first pair of TSs has a first pre-assigned priority (e.g., manually assigned by an administrator) and the second pair of TSs has a second pre-assigned priority (e.g., manually assigned by an administrator), the notification may be a status notification and may indicate the first pre-assigned priority and the second pre-assigned priority or indicate which of the first pair of TSs and the second pair of TSs has a higher or lower pre-assigned priority. In this case, the pre-assigned priorities are to be followed in packet forwarding.

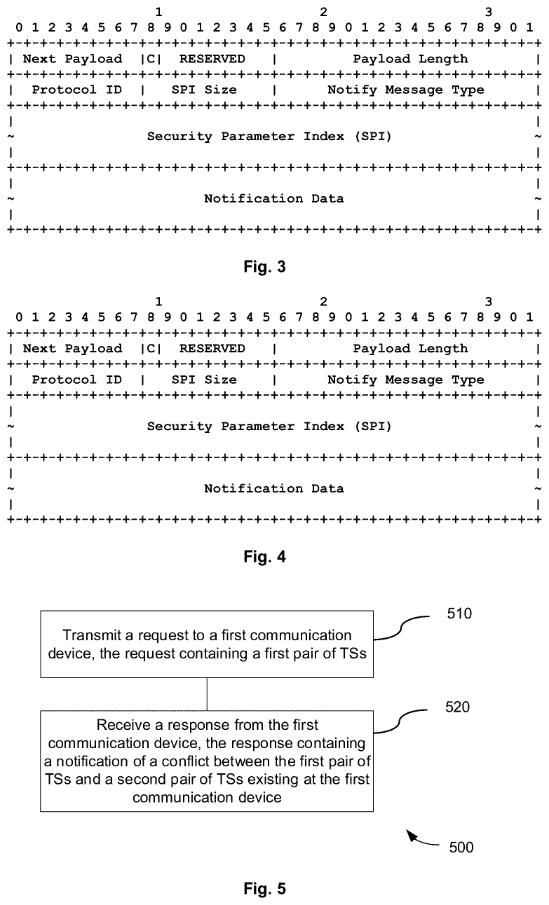

FIG. 3 shows a message format for a status notification. Here, an IKE Notify Payload Status Type TS_PRIORITY_ASSIGN is defined. For example, a type value 52000 may be used, which is in the private use range, referring to Internet Key Exchange Version 2 (IKEv2) Parameters available at iana.org, see below.

| Value | NOTIFY MESSAGES—STATUS TYPES |
|---|---|
| 52000 | TS_PRIORITY_ASSIGN (Private use) |

The fields in FIG. 3 can be defined as follows:
Next Payload—N(41), indicates this is Notify payload;
C=0—recipient to skip this payload if it does not understand the payload type code;
Protocol ID—this field must contain either (2) to indicate AH or (3) to indicate ESP;
SPI Size—length in octets of the child SA SPI;
Notify Message Type—TS_PRIORITY_ASSIGN (52000);
Notification data for TS_PRIORITY_ASSIGN should be a plaintext string, indicating conflicting TS pairs and priority information (e.g., “TS Pair 1 overlaps TS Pair 2, with TS Pair 1 having a higher pre-assigned priority”).

For example, the IKE_AUTH response at 1.4 in FIG. 1 can be extended to contain HDR, SK {IDr, [CERT,] AUTH, SAr2, TSi, TSr, N(TS_PRIORITY_ASSIGN)}. Additionally or alternatively, the CREATE_CHILD_SA response at 1.6 in FIG. 1 can be extended to contain HDR, SK {SA, Nr, [KEr,] TSi, TSr, N(TS_PRIORITY_ASSIGN)}.

In another example, when neither of the first pair of TSs and the second pair of TSs has a pre-assigned priority, and when neither of the first pair of TSs and the second pair of TSs is completely included by the other, the notification may be an error notification.

FIG. 4 shows a message format for an error notification. Here, an IKE Notify Payload Error Type TS_CONFLICT is defined. For example, a type value 8866 may be used, which is in the private use range, referring to Internet Key Exchange Version 2 (IKEv2) Parameters available at iana.org, see below.

| Value | NOTIFY MESSAGES—STATUS TYPES |
|---|---|
| 8866 | TS_CONFLICT (Private use) |

The fields in FIG. 4 can be defined as follows:
Next Payload—N(41), indicates this is Notify payload;
C=0—recipient to skip this payload if it does not understand the payload type code;
Protocol ID—this field must contain either (2) to indicate AH or (3) to indicate ESP;
SPI Size—length in octets of the child SA SPI;
Notify Message Type—TS_CONFLICT (8866);
Notification data for TS_CONFLICT should be a plaintext string, indicating conflicting TS pairs (e.g., “TS Pair 1 overlaps TS Pair 2”).

For example, the IKE_AUTH response at 1.4 in FIG. 1 can be extended to contain HDR, SK {IDr, [CERT,] AUTH, SAr2, TSi, TSr, N(TS_CONFLICT)}. Additionally or alternatively, the CREATE_CHILD_SA response at 1.6 in FIG. 1 can be extended to contain HDR, SK {SA, Nr, [KEr,] TSi, TSr, N(TS_CONFLICT)}.

In yet another example, when neither of the first pair of TSs and the second pair of TSs has a pre-assigned priority, and when one of the first pair of TSs and the second pair of TSs is completely included by the other, the first communication device may assign a first priority to the one pair of TSs and a second priority to the other pair of TSs. The first priority is higher than the second priority. In this case, the notification may be a status notification and may indicate the first priority and the second priority or indicate which of the first pair of TSs and the second pair of TSs has a higher or lower priority assigned at the first communication device.

Here, the first priority and the second priority may be referred to as automatically assigned priorities, as opposed to pre-assigned or manually assigned priorities by an administrator. The first priority and the second priority may be assigned in response to a priority assignment (automatic assignment) function being enabled. That is, the priority assignment function can be enabled or disabled, e.g., by an administrator, to provide flexibility in configuration.

In this case, referring to the FIG. 3, the notification data may indicate: “TS Pair 1 is completely included by TS Pair 2, with TS Pair 1 having a higher auto-assigned priority.”

In still another example, when neither of the first pair of TSs and the second pair of TSs has a pre-assigned priority, and when one of the first pair of TSs and the second pair of TSs is completely included by the other and a priority assignment (automatic assignment) function is disabled, the notification may be an error notification. In this case, referring to the FIG. 4, the notification data may indicate: “TS Pair 1 is completely included by TS Pair 2.”

Here, an error notification may cause a negotiation failure and thus termination of an IKE session.

FIG. 5 is a flowchart illustrating a method 500 according to an embodiment of the present disclosure. The method 500 can be performed by a second communication device, e.g., the initiator shown in FIG. 1.

At block 510, a request is transmitted to a first communication device (e.g., the responder shown in FIG. 1). The request contains a first pair of TSs (e.g., TSi and TSr as described above).

At block 520, a response is received from the first communication device. The response contains a notification of a conflict between the first pair of TSs and a second pair of TSs existing at the first communication device.

Here, for example, the request may be an IKE_AUTH request (e.g., as shown at 1.3 of FIG. 1) and the response may be an IKE_AUTH response (e.g., as shown at 1.4 of FIG. 1). Alternatively, the request may be a CREATE_CHILD_SA request (e.g., as shown at 1.5 of FIG. 1) and the response may be a CREATE_CHILD_SA response (e.g., as shown at 1.6 of FIG. 1).

In an example, the notification may be an error notification. As described above in connection with FIG. 4, for example, the notification data may indicate: “TS Pair 1 overlaps TS Pair 2.” The error notification may cause a negotiation failure and thus termination of an IKE session.

In another example, the notification may be a status notification and may indicate a priority of the first pair of TSs and a priority of the second pair of TSs or indicate which of the first pair of TSs and the second pair of TSs has a higher or lower priority. Here, each priority may be a pre-assigned priority (e.g., manually assigned by an administrator) or a priority assigned at the first communication device. As described above in connection with FIG. 3, for example, the notification data may indicate: “TS Pair 1 overlaps TS Pair 2, with TS Pair 1 having a higher pre-assigned priority,” or “TS Pair 1 is completely included by TS Pair 2, with TS Pair 1 having a higher auto-assigned priority.”

The notification data (in either error notification or status notification) can be represented to the administrator, so as to e.g., allow the administrator to review or change TS configurations.

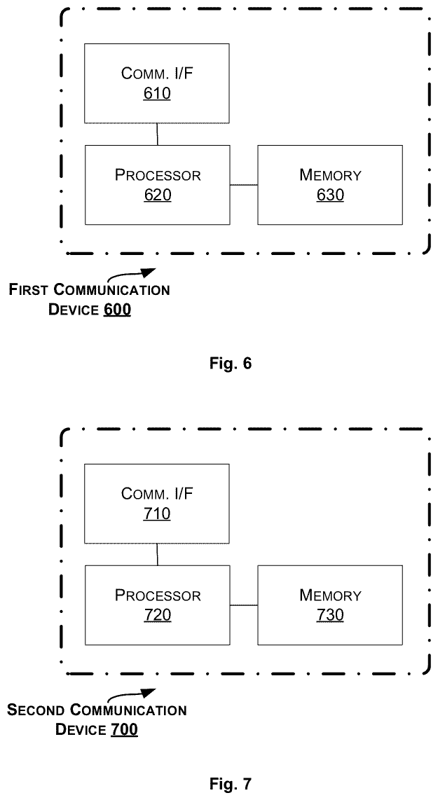

FIG. 6 is a block diagram of a first communication device 600 according to another embodiment of the present disclosure.

The first communication device 600 includes a communication interface 610, a processor 620 and a memory 630. The memory 630 may contain instructions executable by the processor 620 whereby the first communication device 600 is operative to perform the actions, e.g., of the procedure described earlier in conjunction with FIG. 2. Particularly, the memory 630 may contain instructions executable by the processor 620 whereby the first communication device 600 is operative to: receive a request from a second communication device, the request containing a first pair of TSs; and transmit a response to the second communication device. When the first pair of TSs and a second pair of TSs existing at the first communication device at least partially overlap, the response contains a notification of a conflict between the first pair of TSs and the second pair of TSs.

In an embodiment, when the first pair of TSs has a first pre-assigned priority and the second pair of TSs has a second pre-assigned priority, the notification may be a status notification and may indicate the first pre-assigned priority and the second pre-assigned priority or indicates which of the first pair of TSs and the second pair of TSs has a higher or lower pre-assigned priority.

In an embodiment, the notification may be an error notification when neither of the first pair of TSs and the second pair of TSs has a pre-assigned priority, and when neither of the first pair of TSs and the second pair of TSs is completely included by the other.

In an embodiment, the memory 630 may further contain instructions executable by the processor 620 whereby the first communication device 600 is operative to, when neither of the first pair of TSs and the second pair of TSs has a pre-assigned priority, and when one of the first pair of TSs and the second pair of TSs is completely included by the other: assign a first priority to the one pair of TSs and a second priority to the other pair of TSs. The first priority is higher than the second priority. The notification may be a status notification and may indicate the first priority and the second priority or indicates which of the first pair of TSs and the second pair of TSs has a higher or lower priority assigned at the first communication device.

In an embodiment, the first priority and the second priority may be assigned in response to a priority assignment function being enabled.

In an embodiment, the notification may be an error notification when neither of the first pair of TSs and the second pair of TSs has a pre-assigned priority, and when one of the first pair of TSs and the second pair of TSs is completely included by the other and a priority assignment function is disabled.

In an embodiment, the request may be an IKE_AUTH request and the response may be an IKE_AUTH response, or the request may be a CREATE_CHILD_SA request and the response may be a CREATE_CHILD_SA response.

In an embodiment, the notification may be included in the response in response to a conflict notification function being enabled.

FIG. 7 is a block diagram of a second communication device 700 according to another embodiment of the present disclosure.

The second communication device 700 includes a communication interface 710, a processor 720 and a memory 730. The memory 730 may contain instructions executable by the processor 720 whereby the second communication device 700 is operative to perform the actions, e.g., of the procedure described earlier in conjunction with FIG. 5. Particularly, the memory 730 may contain instructions executable by the processor 720 whereby the second communication device 700 is operative to: transmit a request to a first communication device, the request containing a first pair of TSs; and receive a response from the first communication device. The response contains a notification of a conflict between the first pair of TSs and a second pair of TSs existing at the first communication device.

In an embodiment, the notification may be an error notification.

In an embodiment, the notification may be a status notification and may indicate a priority of the first pair of TSs and a priority of the second pair of TSs or indicate which of the first pair of TSs and the second pair of TSs has a higher or lower priority.

In an embodiment, each priority may be a pre-assigned priority or a priority assigned at the first communication device.

In an embodiment, the request may be an IKE_AUTH request and the response may be an IKE_AUTH response, or the request may be a CREATE_CHILD_SA request and the response may be a CREATE_CHILD_SA response.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 620 causes the first communication device 600 to perform the actions, e.g., of the procedure described earlier in conjunction with FIG. 2, or code/computer readable instructions, which when executed by the processor 720 causes the second communication device 700 to perform the actions, e.g., of the procedure described earlier in conjunction with FIG. 5.

The computer program product may be configured as a computer program code structured in computer program modules. The computer program modules could essentially perform the actions of the flow illustrated in FIG. 2 or 5.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried in a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method performed by a first communication device, comprising:
receiving a request from a second communication device, the request containing a first pair of Traffic Selectors, TSs; and
transmitting a response to the second communication device, wherein when the first pair of TSs and a second pair of TSs existing at the first communication device at least partially overlap, the response contains a notification of a conflict between the first pair of TSs and the second pair of TSs.

2. The method of claim 1, wherein when the first pair of TSs has a first pre-assigned priority and the second pair of TSs has a second pre-assigned priority, the notification is a status notification and indicates the first pre-assigned priority and the second pre-assigned priority or indicates which of the first pair of TSs and the second pair of TSs has a higher or lower pre-assigned priority.

3. The method of claim 1, wherein the notification is an error notification when neither of the first pair of TSs and the second pair of TSs has a pre-assigned priority, and when neither of the first pair of TSs and the second pair of TSs is completely included by the other.

4. The method of claim 1, further comprising, when neither of the first pair of TSs and the second pair of TSs has a pre-assigned priority, and when one of the first pair of TSs and the second pair of TSs is completely included by the other:
assigning a first priority to the one pair of TSs and a second priority to the other pair of TSs, the first priority being higher than the second priority,
wherein the notification is a status notification and indicates the first priority and the second priority or indicates which of the first pair of TSs and the second pair of TSs has a higher or lower priority assigned at the first communication device.

5. The method of claim 4, wherein the first priority and the second priority are assigned in response to a priority assignment function being enabled.

6. The method of claim 1, wherein the notification is an error notification when neither of the first pair of TSs and the second pair of TSs has a pre-assigned priority, and when one of the first pair of TSs and the second pair of TSs is completely included by the other and a priority assignment function is disabled.

7. The method of claim 1, wherein
the request is an Internet Key Exchange, IKE, Authentication, IKE_AUTH, request, and the response is an IKE_AUTH response, or
the request is a Create Child Security Association, CREATE_CHILD_SA, request, and the response is a CREATE_CHILD_SA response.

8. The method of claim 1, wherein the notification is included in the response in response to a conflict notification function being enabled.

9. A method performed by a second communication device, comprising:
transmitting a request to a first communication device, the request containing a first pair of Traffic Selectors, TSs; and
receiving a response from the first communication device, the response containing a notification of a conflict between the first pair of TSs and a second pair of TSs existing at the first communication device.

10. The method of claim 9, wherein the notification is an error notification.

11. The method of claim 9, wherein the notification is a status notification and indicates a priority of the first pair of TSs and a priority of the second pair of TSs or indicates which of the first pair of TSs and the second pair of TSs has a higher or lower priority.

12. The method of claim 11, wherein each priority is a pre-assigned priority or a priority assigned at the first communication device.

13. The method of claim 9, wherein
the request is an Internet Key Exchange, IKE, Authentication, IKE_AUTH, request, and the response is an IKE_AUTH response, or
the request is a Create Child Security Association, CREATE_CHILD_SA, request, and the response is a CREATE_CHILD_SA response.

14. A first communication device, comprising a communication interface, a processor and a memory, the memory comprising instructions executable by the processor whereby the first communication device is operative to perform the method according to claim 1.

15-19. (canceled)
